(19) United States
(12) Patent Application Publication
(10) Pub. No.: US 2025/0144852 A1
(43) Pub. Date: May 8, 2025

(54) ROTARY CLAMP ARM

(71) Applicant: BRIDGESTONE BANDAG, LLC, Nashville, TN (US)

(72) Inventor: Troy A. Kost, Muscatine, IA (US)

(73) Assignee: BRIDGESTONE BANDAG, LLC, Nashville, TN (US)

(21) Appl. No.: 18/838,466

(22) PCT Filed: Feb. 15, 2023
(86) PCT No.: PCT/US2023/062614

§ 371 Date: Aug. 14, 2024

Related U.S. Application Data
(60) Provisional application No. 63/310,337, filed on Feb. 15, 2022.

(51) Int. Cl. B29C 37/00; B29D 30/52

(52) U.S. Cl. CPC B29C 37/0017; B29D 30/52

(57) ABSTRACT

A tread extractor assembly for removing a molded article from a mold is provided. The tread extractor assembly includes a chassis, a first spindle rotatably coupled to the chassis, and a second spindle rotatably coupled to the chassis. The first spindle is configured to rotate in a first direction and the second spindle is configured to rotate in a second direction opposite to the first direction. The first spindle and the second spindle are disposed to extend substantially in parallel to one another and are separated by a gap. The gap is configured to receive a portion of the molded article such that the portion of the molded article is clamped between the first spindle and the second spindle during extraction of the molded article from the mold.

### FIELD

The present disclosure relates generally to molding of materials including rubber composite materials.

### BACKGROUND

Molded articles may be formed when a preform of an article is placed in a mold for shaping. Removal of the article from the mold may be performed after a forming operation is complete, without causing damage to the molded article. Removal is often carried out as a separate operation during the manufacturing process.

In the field of tire manufacturing, a common molding operation includes vulcanizing a rubber composite material in a curing press. Curing presses include molds that enclose a rubber composite preform to provide pressure, and heat cures the preform into a useable article, for example, a strip or belt of tire tread. Such tire treads are typically used in tire retreading and other applications.

A typical curing press mold includes a mold plate that forms a cavity. One side of the cavity forms various depressions and ridges that correspond to the desired tread pattern of the tire tread that will emerge therefrom. A plate or platen is placed over the mold cavity after a tread preform has been loaded into the cavity. Pressure and heat are provided by the press to force the preform to assume the shape of the mold cavity and to cure the preform into vulcanized rubber.

### SUMMARY

Depending on the shape, placement, and orientation of various physical features of the molded article, removal of the article from a mold may require special care and handling to avoid tearing, breakage, or other damage. Various exemplary embodiments described herein provide a reduced likelihood of such damage.

At least one embodiment relates to a tread extractor assembly for removing a tire tread from a tread mold. The tread extractor assembly includes a chassis, a first spindle rotatably coupled to the chassis, and a second spindle rotatably coupled to the chassis. The first spindle is configured to rotate in a first rotational direction, and the second spindle is configured to rotate in a second rotatable direction opposite to the first rotational direction. The first spindle and the second spindle extend substantially parallel to one another, and are separated by a gap. The gap is configured to receive a portion of the tire tread such that the portion of the tire tread is clamped between the first spindle and the second spindle during a processes of extracting the tire tread from the tread mold.

At least one embodiment relates to a method of extracting a tire tread from a tread mold using a tread extractor assembly. The method includes positioning the tread extractor assembly above the tire tread positioned within the tread mold. The method also includes rotating a first spindle and a second spindle. The method also includes extracting a portion of the tire tread from the tread mold using a tab ejector. The method also includes translating the tread extractor assembly toward the portion of the tire tread while the first spindle and the second spindle are rotating. The method also includes clamping the portion of the tire tread between the first spindle and the second spindle. The method also includes stopping rotation of the first spindle and the second spindle. The method also includes pivoting the tread extractor assembly to a tilted position relative to the tread mold. The method also includes translating the tread extractor assembly along the length of the tread mold to extract the tire tread from the tread mold.

This summary is illustrative only and is not intended to be in any way limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a side view of a curing press, according to an example embodiment,

FIG. 2 is a perspective view of a mold of the curing press of FIG. 1,

FIG. 3 is a front, cross-sectional view of the mold of FIG. 2,

FIG. 4 is a perspective view of a tread extractor assembly, according to an example embodiment,

FIG. 5 is a front view of the tread extractor assembly of FIG. 4,

FIG. 6 is a front cross-sectional view of the tread extractor assembly of FIG. 4,

FIG. 7 is a side cross-sectional view of the tread extractor assembly of FIG. 4 along the line AA of FIG. 6,

FIG. 8 is a side cross-sectional view of the tread extractor assembly of FIG. 4 along the line BB of FIG. 5,

FIG. 9 is a perspective side view of the tread extractor assembly of FIG. 4,

FIG. 10 is a perspective view of the tread extractor assembly of FIG. 4 positioned above a tire tread positioned within a mold,

FIG. 11 is a perspective side view of the tread extractor assembly of FIG. 4 engaging the mold of FIG. 10,

FIG. 12 is a perspective side view of the tread extractor assembly of FIG. 4 having a portion of the tire tread clamped therein,

FIG. 13 is a perspective side view of the tread extractor assembly of FIG. 4 having the portion of the tire tread clamped therein and pivoted toward the tire tread positioned within the mold, and

FIG. 14 is a method of extracting a tire tread from a mold using the tread extractor assembly of FIG. 4.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a tread extractor assembly is provided. The tread extractor assembly is configured to selectively grip a tire tread that lies within a mold and to extract (e.g., remove, pull) the tire tread from (e.g., out of) the mold. In some embodiments, the tread extractor assembly is coupled to a rail assembly that translates the tread extractor assembly back and forth in a linear direction along the mold. The tire tread may be selectively coupled to the tread extractor assembly. The rail assembly may then translate the tread extractor assembly in a direction along the mold such that the tire tread is removed from the mold. In some embodiments, the tire tread is positioned within the mold such that the pattern side is face-down (e.g., facing away from the tread extractor assembly). Thus, when the tread extractor assembly grips the tire tread and the rail assembly translates the tread extractor assembly in a direction along the mold, the tire tread is moved (e.g., flipped) such that the tread side is pattern side up (e.g., facing toward the tread extractor assembly).

One advantage of the present system is that the tread extractor assembly and the rail assembly are configured to complete a tread extraction process automatically. For example, a portion of the tire tread may be ejected from the mold automatically, and the portion of the tire tread may be fed into the tread extractor assembly automatically by the engagement between the toothed spindles and the portion of the tire tread. After the portion of the tire tread is clamped within the spindles, the tread extractor assembly may lock the rotation of the spindles such that the spindles are prevented from rotating and the portion of the tire tread is prevented from being removed from the tread extractor assembly until the spindles are unlocked.

In some embodiments, an operator is required to clamp a portion of the tire tread within a tread extractor system. The tread extractor assembly described according to the exemplary embodiments set forth herein advantageously does not require an operator to clamp the tread into the tread extraction assembly.

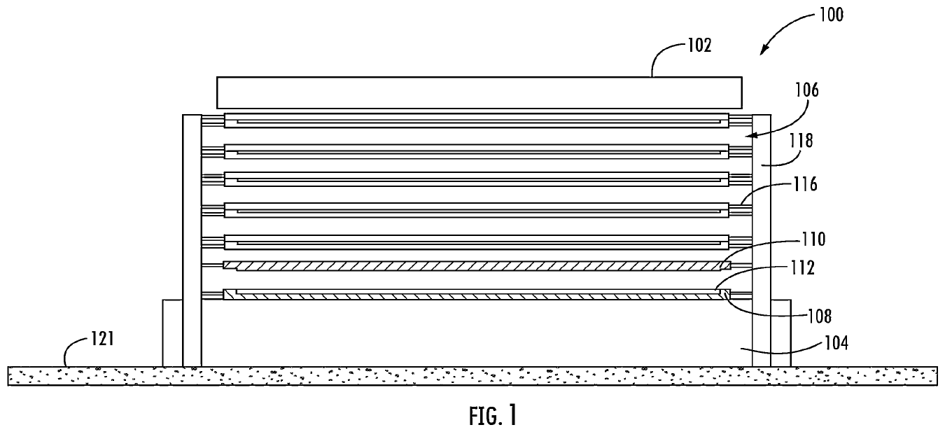

Turning now to FIG. 1, a side view of a curing press 100 is shown. The curing press 100 may be part of a larger tread forming operation that includes, for example, a composite preform building apparatus, a forming press, and other structures (not pictured). The curing press 100 includes top and bottom press blocks 102 and 104. Between the press blocks 102 and 104 are a plurality of mold assemblies 106, where each of the mold assemblies 106 includes two parts, such as an upper mold and a lower mold, that cooperate to define an internal molding cavity 112. In some implementations, the upper mold may be absent. In the illustration of FIG. 1, a mold 108 and a platen 110 make up the mold assembly, but other configurations may be used. For example, what is referred to as mold 108 in connection with FIG. 1 may be positioned in an inverted orientation in the curing press 100 such that a mold cavity 112 is facing down. In such an embodiment, the platen 110 is positioned below the mold 108 such that the platen 110 fits over the mold cavity 112. In the description that follows, a particular orientation having the mold 108 located beneath the platen 110 is discussed for illustration, but it should be appreciated that the relative orientation of these two elements may be different.

Moreover, although six mold assemblies 106 are shown in FIG. 1, a single assembly or a different number of mold assemblies may be used. Each mold 108 forms the mold cavity 112 into which a preform is packed or loaded. In some embodiments, following the application of pressure and heat to the closed mold assembly 106, a vulcanized tread 114 (e.g., tread, tire tread, etc.) is ready to emerge from the mold cavity 112. In other alternatives, the curing press 100 may be configured to provide continuous manufacture of the molded article or the tire tread 114 in a belt form or another form.

The curing press 100 further includes linkages 116 that connect the parts of each mold assembly 106 to frame members or posts 118, which include mechanisms (not shown) that can selectively move the various parts of each mold assembly 106 vertically to enable the loading of preforms and the unloading of finished treads from each mold assembly 106.

As discussed in greater detail herein, a tread extractor assembly may be connected to a horizontally extending rail 121 by a rail assembly. The rail assembly, and thus the tread extractor assembly, is configured to traverse the curing press 100 at least along the rail 121, the rail 121 extending along the length of the curing press 100. In some embodiments, a tread extractor assembly is associated with each of the mold assemblies 106. For example, if the curing press 100 includes six mold assemblies, then six tread extractor assemblies may facilitate removal of the tread from each of the mold assemblies, and each of the six tread extractor assemblies may traverse the curing press 100 along the rail 121.

In a forming process for the tire tread 114, a tread preform, which may be built by successively stacking layers of rubber with other materials such as thread, fabric, steel belts, wire mesh and the like, is loaded into the mold 108. Each mold 108 has ridges and depressions (e.g., mold features) formed therein that will shape and mold the lugs and sipes of a desired pattern in the emerging tire tread 114. The platen 110 is placed in opposed relationship to the mold cavity 112 and a curing process ensues that vulcanizes the preform into the tire tread 114. The tire tread 114 is thereafter detached and removed from the mold 108.

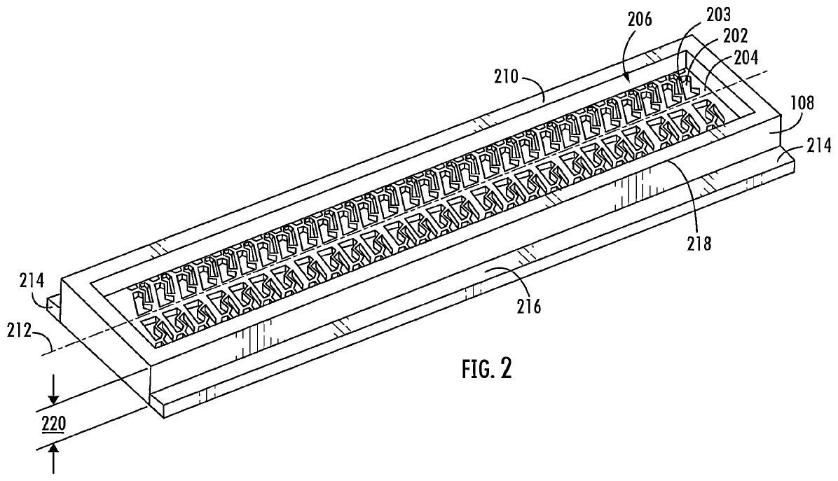

When forming the tire tread 114, the mold 108 imprints onto the preform a predetermined pattern of lugs and/or ribs. Referring to FIG. 2, these lugs are formed as depressions 202 in a bottom surface 204 of the mold 108, which are separated by sipe blades or ridges 203. The mold 108 forms an internal cavity 206 that is open from the top and surrounded by the bottom surface 204 and walls 210 that extend around the perimeter of the cavity 206. Although a mold configured to form a single tread strip is shown, the mold 108 may include two or more additional cavities extending parallel to one another and configured to form two or more tread strips from a single preform. In the illustrated embodiment, the single-cavity mold 108 has a generally elongated rectangular shape that extends along an axis 212.

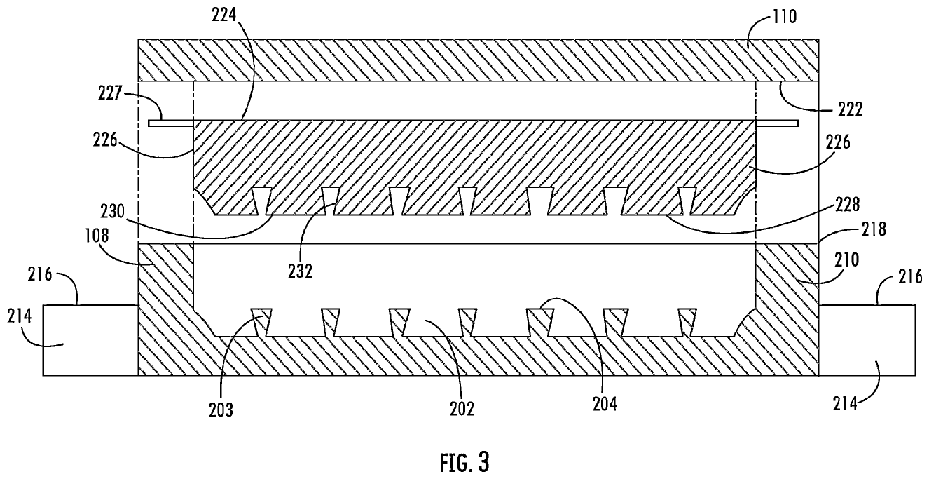

A cross section of the mold assembly 106 during a molding operation phase is shown in FIG. 3. In this illustration, the mold assembly 106 is shown opened following a molding and curing operation for the tread 114. The top mold or platen 110 includes a bottom surface 222 that forms the mounting surface (e.g., top surface, inner surface, rear surface) 224 of the tire tread 114. The lateral surfaces 226 and the outer or tread surface 228 of the tire tread 114 are formed, respectively, by the sidewalls 210 and bottom surface 204 of the mold 108. Flash 227 may remain on the tire tread 114 along the interface between the platen 110 and the mold 108. A plurality of lugs 230 arranged along the tread surface 228 are formed by the corresponding lug depressions 202. In some embodiments, the flash 227 is configured to be selectively coupled to the tread extractor assembly. For example, the flash 227 may provide a convenient tab, extension or protrusion (e.g., a protruding portion) of the tire tread 114 that the tread extractor assembly can selectively couple to in order to facilitate removal of the tire tread 114 from the mold cavity 112.

As may be seen in the cross section of FIG. 3, certain tread patterns may include small and/or negative draft angles formed in the surfaces around the sides of the lugs 230. Draft angle denotes the resulting angle formed by mold surfaces relative to the direction of removal of the molded article from the mold. Accordingly, positive draft angles are disposed such that the removal of the molded article is facilitated, whereas negative draft angles are disposed such that at least some deformation of the molded article is required to remove the molded article from the mold. In the cross section of FIG. 3, the lugs 230 have negative draft angles on their side surfaces 232, which have been exaggerated for the sake of illustration. As can be appreciated, certain portions of the lugs undergo elastic deformation when removing the tread 114 from the mold 108. The mold 108 further includes two tracks or ledges 214 extending lengthwise along the sides of the mold 108 generally parallel to the axis 212. Each ledge 214 is disposed on one side of the mold 108 and includes a track 216 that extends generally parallel to a top edge 218 of the side portion of the wall 210 at an offset vertical distance 220 therefrom. Although the ledges 214 are shown to have a length that is about equal to the overall length of the mold 108 in FIG. 2, the ledges 214 can extend past the ends of the mold 108. In some embodiments, the tread extractor assembly engages a portion of the mold 108, such as the top edge 218 or the ledges 214, when removing the tire tread 114 from the mold 108. For example, in embodiments where a larger amount of force is required to remove the tire tread 114 from the mold 108, the tread extractor assembly may leverage (e.g., brace itself) against either of the top edge 218 and/or the ledges 214. In this way, the likelihood of damage may be mitigated. Further, in some embodiments, the tread extractor assembly engages the mold 108 as the tread extractor assembly is translated along the length of the mold 108 during an extraction process. In some embodiments, the tread extractor assembly includes wheels that roll along the mold 108 during a tread extraction process.

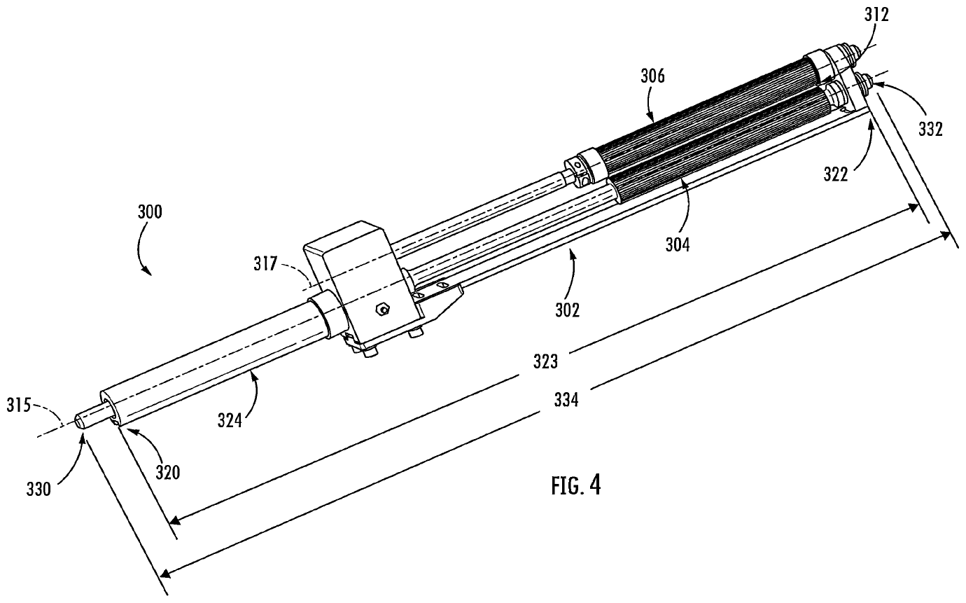

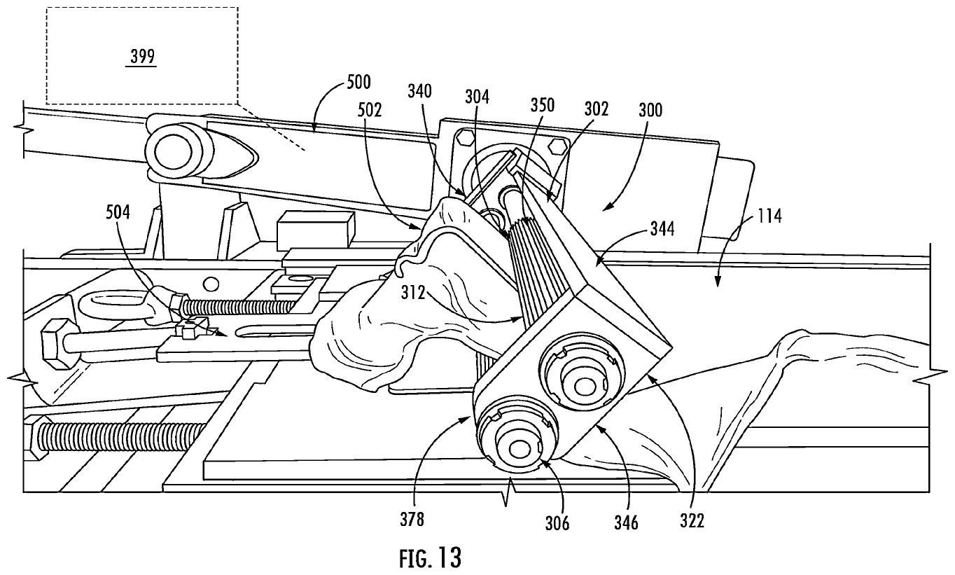

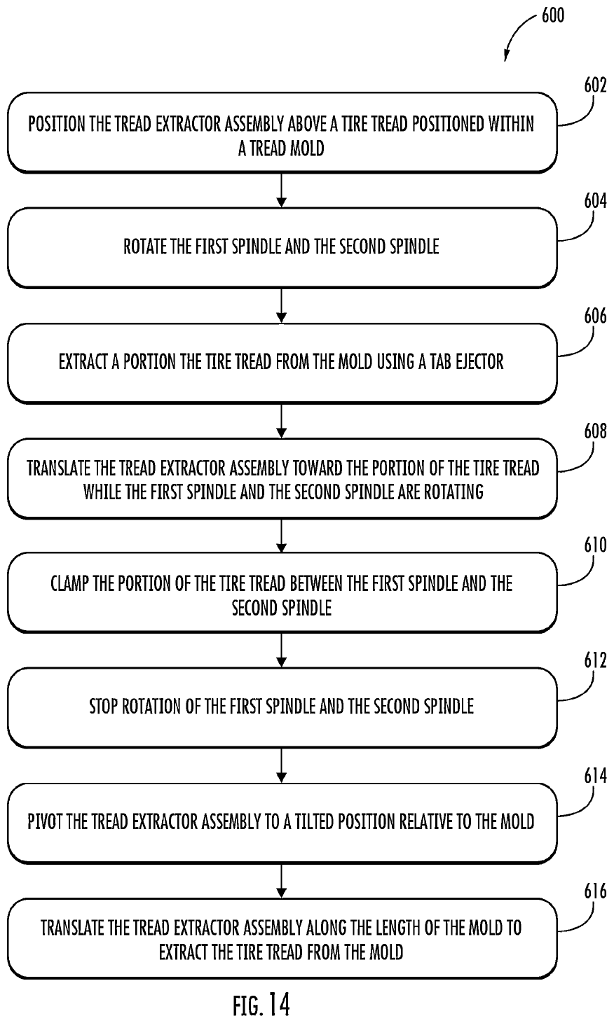

Referring now to FIG. 4, a perspective view of a tread extractor assembly 300 is shown. The tread extractor assembly 300 includes a chassis 302, a first spindle 304, and a second spindle 306. The chassis 302 is configured to be pivotally coupled to a rail assembly (e.g., the rail assembly 500 of FIG. 13) such that the chassis 202 is pivotable (e.g., rotatable) relative to the rail assembly about a first axis 315. The first spindle 304 and the second spindle 306 are rotatably coupled to the chassis 302. The first spindle 304 is rotatable relative to the chassis 302 about the first axis 315 and the second spindle 306 is rotatable relative to the chassis 302 about a second axis 317. The second axis 317 is substantially parallel to the first axis 315. In some embodiments, the first axis 315 and the second axis 317 are offset by between about 0 degrees to about 10 degrees.

The first spindle 304 and the second spindle 306 are radially displaced from one another such that the first spindle 304 and the second spindle 306 are separated by a gap 312 configured to receive a portion of a tire tread, such as the tire tread 114. After a tire tread is cured within the mold 108, the tread extractor assembly 300 is positioned within the press 100 proximate an end of the mold 108. A portion of the tire tread, such as flash or a tab, is inserted into the gap 312 and clamped between the first spindle 304 and the second spindle 306. The first spindle 304 and the second spindle 306 may be rotated such that the portion of the tire tread is fed in between and clamped between the first spindle 304 and the second spindle 306. After the portion of the tire tread is positioned within the gap 312 and clamped between the first spindle 304 and the second spindle 306, the first spindle 304 and the second spindle 306 are locked and prevented from rotating. After the first spindle 304 and the second spindle 306 are locked, the chassis 302 is rotated about the first axis 315 such that the tire tread (or the portion of the tire tread) is further wrapped around either the first spindle 304 or the second spindle 306. Pivoting the chassis 302 increases the grip on the tire tread by the tread extractor assembly 300. The tread 114 may eventually be removed from the tread extractor assembly 300 after unlocking the first spindle 304 and the second spindle 306 and rotating both the first spindle 304 and the second spindle 306.

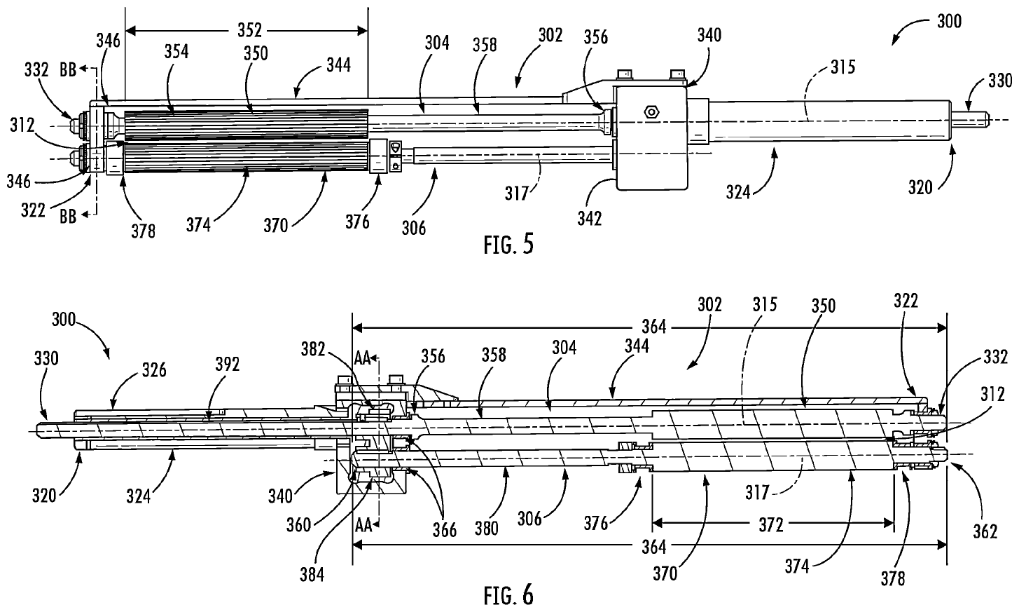

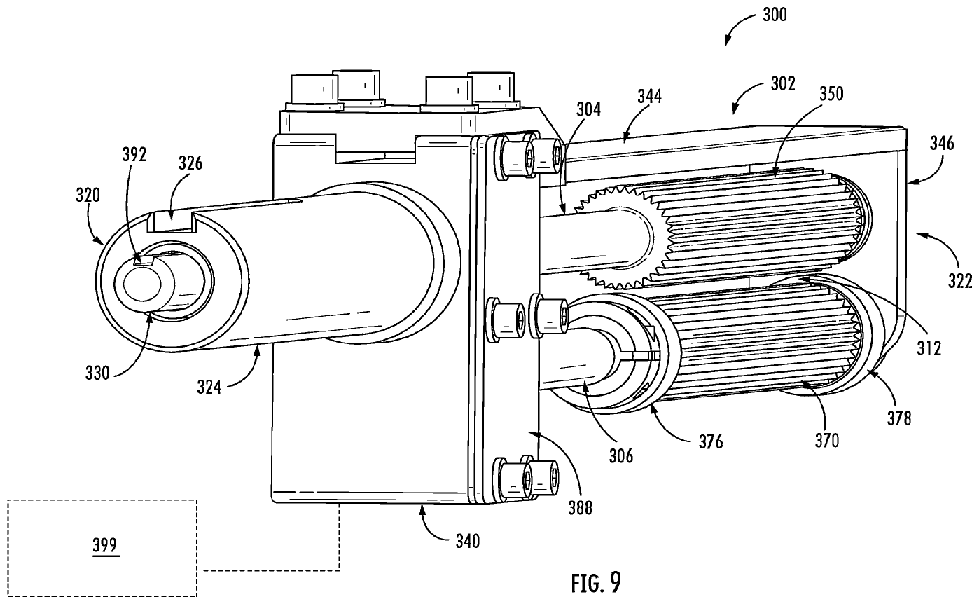

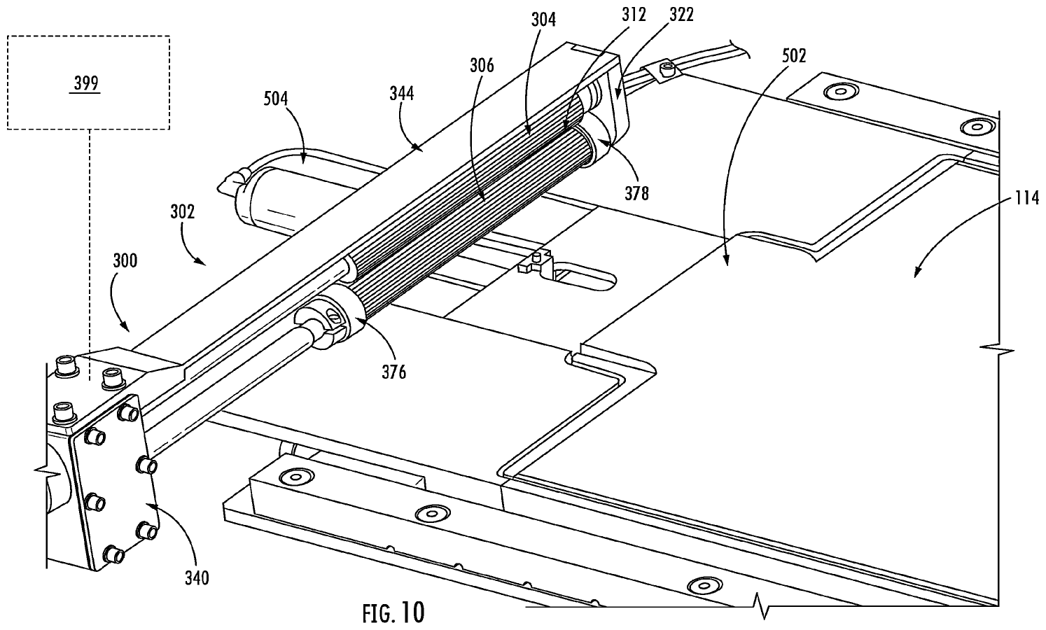

The chassis 302 includes a first chassis end 320 and a second chassis end 322 opposite to the first chassis end 320. The first chassis end 320 and the second chassis end 322 are separated by a chassis length 323. The first chassis end 320 is configured for coupling to a rail assembly. Positioned at the first chassis end 320 is a cylindrical body 324 configured for coupling with the rail assembly. In some embodiments, the cylindrical body 324 includes a chassis key receiver or seat 326 (FIGS. 6 and 9). The key receiver 326 is configured to accept a key to rigidly couple the chassis 302 to the rail assembly, such that rotation of a portion of the rail assembly causes rotation of the chassis 302 about the first axis 315.

Further, the first spindle 304 has a first spindle end 330 and a second spindle end 332 separated by a first spindle length 334. The first spindle length 334 is greater than the chassis length 323 such that the first spindle end 330 extends beyond the first chassis end 320 along the first axis 315. The first spindle end 330 is configured for coupling to an actuator of the rail assembly configured to rotate the first spindle 304 about the first axis 315 relative to the chassis 302. The second spindle end 332 is rotatably coupled to the second chassis end 322 such that the first spindle 304 is rotatable about the first axis 315 relative to the chassis 302.

Referring now to FIG. 5, the tread extractor assembly 300 further includes a gearbox 340 coupled to the chassis 302. The gearbox 340 is positioned between the first chassis end 320 and the second chassis end 322. The gearbox 340 is fluidly sealed and configured to hold lubricant, such as oil, grease, and the like. Both the first spindle 304 and the second spindle 306 extend into the gearbox 340 and are rotatably coupled to the gearbox 340. More specifically, the first spindle 304 and the second spindle 306 extend into a sidewall 342 of the gearbox 340 and are rotatably coupled to the sidewall 342. Within the gearbox 340, the first spindle 304 and the second spindle 306 operably engage one another such that rotation of the first spindle 304 about the first axis 315 causes the rotation of the second spindle 306 about the second axis 317.

The chassis 302 further includes a first chassis flange 344 coupled to the gearbox 340 and extending from the gearbox 340 to the second chassis end 322. The first chassis flange 344 may be formed of or include metal, plastic, wood, similar materials or combinations thereof. The first chassis flange 344 contributes to the rigidity of the chassis 302, such that rotation of the chassis 302 does not cause warping or bending of the first spindle 304 and the second spindle 306. The first chassis flange 344 acts as a guard to protect the first spindle 304 from damage. The chassis 302 further includes a second chassis flange 346 coupled to the first chassis flange 344 and extending orthogonally away from the first chassis flange 344 proximate to the second chassis end 322.

In some embodiments, the second chassis flange 346 is first formed separately from the first chassis flange 344 and is then coupled to the first chassis flange 344 during an assembly step. In some embodiments, the first chassis flange 344 and the second chassis flange 346 are integrally formed with one another. As utilized herein, two or more elements are “integrally formed” with each other when the two or more elements are formed and joined together as part of a single manufacturing process to create a single-piece or unitary construction that cannot be disassembled without at least partial destruction of the overall component.

Referring again to FIG. 5, the first spindle end 330 is rotatably coupled to the second chassis flange 346 such that the first spindle 304 is rotatable about the first axis 315. The first spindle 304 further includes a first engagement portion (e.g., engagement surface) 350. The first engagement portion 350 extends along a length of the first spindle 304 between the second chassis flange 346 and the gearbox 340. In some embodiments, the first engagement portion 350 extends along half a length of the first spindle 304 between the second chassis flange 346 and the gearbox 340. The first engagement portion 350 has a first portion length 352 equal to approximately one-half of the distance between the second chassis flange 346 and the gearbox 340. In some embodiments, the first portion length 352 is approximately equal to the distance between the second chassis flange 346 and the gearbox 340.

The first engagement portion 350 of the first spindle 304 includes a plurality of first teeth 354 that extend radially away from the first spindle 304 in a direction radially away from the first axis 315. The plurality of first teeth 354 are configured to provide additional grip to a portion of a tire tread, such as a tab, positioned within the gap 312 between the first spindle 304 and the second spindle 306. The first spindle 304 further includes a spindle stopper 356 coupled to the first spindle 304 proximate to the sidewall 342 of the gearbox 340. The spindle stopper 356 has a diameter greater than a diameter of the aperture in the sidewall 342 through which the first spindle 304 extends. The spindle stopper 356 is configured to prevent (e.g., limit) axial movement of the first spindle 304 along the first axis 315 relative to the chassis 302. The spindle stopper 356 is coupled to the first spindle 304 between the first engagement portion 350 and the gearbox 340. In some embodiments, the spindle stopper 356 is integrally formed with the first spindle 304, such as by lathing, forging, milling, and similar manufacturing steps.

The first spindle 304 further includes a first non-engagement portion 358. The first non-engagement portion extends between the first spindle end 330 and the first engagement portion 350. The first non-engagement portion 358 extends through the gearbox 340 and through the cylindrical body 324 until the first spindle end 330 extends beyond the first chassis end 320. In some embodiments, a portion of the first non-engagement portion 358 is positioned between the first engagement portion 350 and the gearbox 340. The first non-engagement portion 358 may be smooth through most of a length of the first non-engagement portion 358. The first non-engagement portion 358 defines a substantially cylindrical body 324 having a diameter that is less than the diameter of the first engagement portion 350 such that the first non-engagement portion 358 is positionable within the cylindrical body 324 and the first engagement portion 350 is not positionable within the cylindrical body 324.

Referring now to FIG. 6, a cross-sectional view of the tread extractor assembly 300 is shown, according to an example embodiment. The first non-engagement portion 358 is shown extending through the cylindrical body 324. The second spindle 306 includes a second spindle first end 360 and a second spindle second end 362 opposite to the second spindle first end 360. The second spindle first end 360 is separate from the second spindle second end 362 by a second spindle length 364. The second spindle length 364 is less than the first spindle length 334 and the second spindle length 364 is less than the chassis length 323. The second spindle length 364 is greater than a length of the first chassis flange 344. The second spindle first end 360 is positioned within the gearbox 340 and the second spindle second end 362 is positioned proximate to the second chassis end 322. The second spindle second end 362 is rotatably coupled to the second chassis flange 346 such that the second spindle 306 is rotatable about the second axis 317 relative to the chassis 302.

Further, the second spindle 306 is rotatably coupled to the sidewall 342 of the gearbox 340 proximate to the second spindle first end 360. Both the first spindle 304 and the second spindle 306 may be rotatably coupled to the sidewall 342 with a bearing 366, a bushing, or a similar structure. While the bearing 366 rotatably coupled with the first spindle 304 is shown in FIG. 6 as being similar to the bearing 366 rotatably coupled with the second spindle 306, it should be appreciated that the bearing 366 may be different for the first spindle 304 and the second spindle 306 in some embodiments.

The second spindle 306 further includes a second engagement portion (e.g., engagement surface) 370. The second engagement portion 370 is positioned radially away from the first engagement portion 350 by the gap 312, so as to be offset from the first engagement portion 350. The second engagement portion 370 extends along a length of the second spindle 306 between the second chassis flange 346 and the gearbox 340. In some embodiments, the second engagement portion 370 extends along half a length of the second spindle 306 between the second chassis flange 346 and the gearbox 340. The second engagement portion 370 has a second portion length 372 equal to approximately half of the distance between the second chassis flange 346 and the gearbox 340. In some embodiments, the second portion length 372 is approximately equal to the distance between the second chassis flange 346 and the gearbox 340.

The second engagement portion 370 of the second spindle 306 includes a plurality of second teeth 374 that extend radially away from the second spindle 306 in a direction radially away from the second axis 317. In some embodiments, instead of the plurality of second teeth 374, the second engagement portion 370 includes knurling, roughening, or a similar finish. The plurality of second teeth 374 are configured to provide additional grip to a portion of a tire tread, such as a tab, positioned within the gap 312 between the first spindle 304 and the second spindle 306. The gap 312 is measured as the distance between the plurality of first teeth 354 and the plurality of second teeth 374. The gap 312 may be adjusted by replacing each of the first spindle 304 and the second spindle 306 with a new third spindle and fourth spindle having greater or smaller radii of teeth. In some embodiments, the gap 312 measures between about 0.5 in. to about 2 in. In some embodiments, the gap 312 measures between about 0.1 in. to about 1 in. In some embodiments, the gap 312 is essentially absent (for example, less than about 0.1 inches), and the plurality of first teeth 354 and the plurality of second teeth 374 mesh together like gear teeth. In some embodiments, the first engagement portion 350 and the second engagement portion 370 are substantially smooth.

The second spindle 306 further includes a first mold engagement body 376 and a second mold engagement body 378 positioned on either end of the second engagement portion 370. Both the first mold engagement body 376 and the second mold engagement body 378 are configured to engage a portion of the tread mold 108, such as the sidewalls 210 or the track 216, during a tread extraction process. Extracting a tire tread from the mold 108 may exert substantial forces on the tread extractor assembly 300 in a direction toward the mold 108. The first mold engagement body 376 and the second mold engagement body 378 are configured to brace the tread extractor assembly 300 against the mold 108 to facilitate removal of the tire tread from the mold 108. The first mold engagement body 376 and the second mold engagement body 378 may be wheels, bearings, bushings, sleeves, or similar cylindrical bodies configured to rotate about a shaft, or any combination thereof. In some embodiments, the first and second mold engagement bodies 376, 378 may differ in structure. Both the first mold engagement body 376 and the second mold engagement body 378 are configured to rotate about the second axis 317.

The second spindle 306 further includes a second non-engagement portion 380. The second non-engagement portion 380 extends between the second spindle first end 360 and the second spindle second end 362. The second non-engagement portion 380 extends through the sidewall 342 of the gearbox 340 until the second spindle first end 360 is disposed within the gearbox 340. In some embodiments, a portion of the second non-engagement portion 380 is positioned between the second engagement portion 370 and the gearbox 340. The second non-engagement portion 380 may be substantially smooth for a majority or an entirety of a length of the second non-engagement portion 380, as shown in FIG. 6. The second non-engagement portion 380 defines a substantially cylindrical body having a diameter that is less than the diameter of the second engagement portion 370, such that the second non-engagement portion 380 is positionable through the sidewall 342 of the gearbox 340 and the second engagement portion 370 is not positionable within the sidewall 342 of the gearbox 340. Further, in some embodiments, a second gear 384 is fixedly coupled to the second spindle 306 and positioned within the gearbox 340 is a second gear 384. The second gear 384 is configured to operably mesh (e.g., engage) the first gear 382 coupled to the first spindle 304.

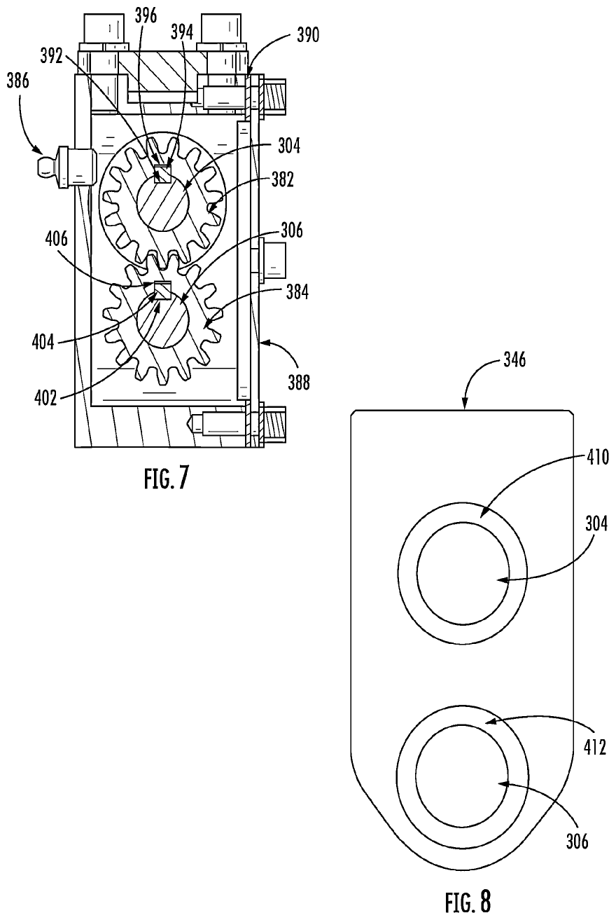

Turning now to FIG. 7, a cross-section view of the gearbox 340 is shown along the line AA of FIG. 6. The gearbox 340 includes a grease plug 386 fluidly coupled to an interior of the gearbox 340 and configured to facilitate an input of grease into the gearbox 340. The gearbox 340 further includes a service cover 388 removably coupled to the gearbox 340 and sealed to the gearbox 340 with a sealing member 390. The sealing member 390 may be a gasket, O-ring, liquid gasket, and the like. The service cover 388 may be removably coupled to the gearbox 340 using fasteners, latches, and the like. Within the gearbox 340 are the first gear 382 and the second gear 384. The first gear 382 is fixedly coupled to the first non-engagement portion 358 of the first spindle 304 such that the first gear 382 rotates about the first axis 315 when the first spindle 304 rotates about the first axis 315. The first spindle 304 may include a first spindle key receiver or seat 392 configured to receive a first spindle key 394, where the first spindle key 394 is received within a first gear keyway 396 of the first gear 382. In some embodiments, the first spindle key receiver or seat 392 extends from proximate to the first gear 382 to the first spindle end 330, as shown in FIG. 6 and FIG. 9. In some embodiments, the first spindle key receiver or seat 392 is configured to receive the first spindle key 394 and an additional key proximate to the first spindle end 330. In such a configuration, the first spindle end 330 may thus be operably coupled to an actuator that is configured to rotate the first spindle 304 about the first axis 315.

The second spindle 306 includes a second spindle key receiver or seat 402 configured to receive a second spindle key 404, where the second spindle key 404 is received within a second gear keyway 406 of the second gear 384. In some embodiments, the second spindle key receiver or seat 402 extends from proximate to the second gear 384 to the second spindle first end 360. As shown in FIG. 7, the first gear 382 and the second gear 384 may be substantially the same in terms of operation. Thus, as the first spindle 304 is rotated about the first axis 315 at a first rotation speed and in a first rotation direction, the meshing of the first gear 382 and the second gear 384 causes the second spindle 306 to rotate about the second axis 317 at a second rotation speed equal to the first rotation speed, and in a second rotation direction opposite to the first rotation direction. In some embodiments, the first gear 382 may have a different amount of teeth from the second gear 384 such that the first rotation speed is different from the second rotation speed.

Referring now to FIG. 8, a cross-sectional view of the second chassis flange 346 is shown at line BB of FIG. 5. The second chassis flange 346 is rotatably coupled to both the first spindle 304 and the second spindle 306. In some embodiments, a first bearing 410 is positioned between the first spindle 304 and the second chassis flange 346 to facilitate rotation of the first spindle 304 relative to the second chassis flange 346, and a second bearing 412 is positioned between the second spindle 306 and the second chassis flange 346 to facilitate rotation of the second spindle 306 relative to the second chassis flange 346. Generally, the first spindle 304 and the second spindle 306 are configured for intermittent operation such that the first bearing 410 and the second bearing 412 may be replaced with bushings and similar structures as appropriate. In some embodiments, the first spindle 304 and the second spindle 306 undergo large lateral loads during a tread extraction process, so the first bearing 410 and the second bearing 412 may be needle bearings that are configured to withstand large lateral loads without failure. The first bearing 410 and the second bearing 412 may be selected from a variety of bearings or bushings configured to allow rotation between the first spindle 304 and the second chassis flange 346, and rotation between the second spindle 306 and the second chassis flange 346.

Turning now to FIG. 9, a perspective view of the tread extractor assembly 300 is shown, according to an example embodiment. The cylindrical body 324 is shown extending away from the gearbox 340 along the first axis 315. The cylindrical body 324 includes a bore through which the first spindle 304 extends. The bore of the cylindrical body 324 extends through the entirety of the cylindrical body 324. The first spindle 304 extends out of the bore of the cylindrical body 324 at an end of the cylindrical body 324 opposite to the gearbox 340 (e.g., at the first chassis end 320). In some embodiments, the first spindle end 330 is rotatably coupled to the cylindrical body 324 proximate to the first chassis end 320. In some embodiments, the first spindle 304 is rotatably coupled to both the second chassis flange 346 and the sidewall 342 of the gearbox 340. Such an arrangement allows the spindle 304 to “float” (in other words, be freely movable within a prescribed region) within the cylindrical body 324 and to be rotatable about the first axis 315 relative to the cylindrical body 324 without engaging any portion of the cylindrical body 324. In some embodiments, the first spindle 304 extends out of the first chassis end 320 at a distance of about 1 in. to about 3 in. The first spindle end 330 is configured to couple to an actuator. The actuator is configured to rotate about the first axis 315 relative to the chassis 302, and the first spindle end 330 is dimensioned to permit such a coupling to the actuator. In particular, the first spindle key receiver seat 392 is provided at the first spindle end 330 and is configured to receive a key for operably coupling the first spindle 304 to an actuator.

Further, in some embodiments, the cylindrical body 324 includes the chassis key receiver or seat 326 configured to receive a key for operably coupling with a chassis actuator of the rail assembly 500. The chassis actuator is configured to rotate the chassis such that the cylindrical body 324 rotates about the first axis 315 and the second spindle 306 rotates about the first spindle 304. In some embodiments, the rail assembly 500 is configured to rotate the chassis 302 and the first spindle 304 in opposite directions about the first axis 315. In some embodiments, the rail assembly 500 is configured to rotate the chassis 302 and the first spindle 304 about the first axis 315 in the same direction, but at different rotational speeds. In some embodiments, the rail assembly 500 is configured to rotate the chassis 302 and the first spindle simultaneously. In some embodiments, the rail assembly 500 rotates the chassis 302 at a different frequency from rotation of the first spindle 304. In some embodiments, a controller 399 configured to control components including the rail assembly 500 may be provided. More specifically, the controller 399 may be a microprocessor or microcomputer having a processor and a memory configured to store instructions to allow for control of operations of the rail assembly 500. The memory may be a non-volatile memory, for example. In some embodiments, the controller 399 of the rail assembly 500 is configured to control the rail assembly 500 and associated components to prohibit rotation of the chassis 302 and the first spindle 304 at the same time.

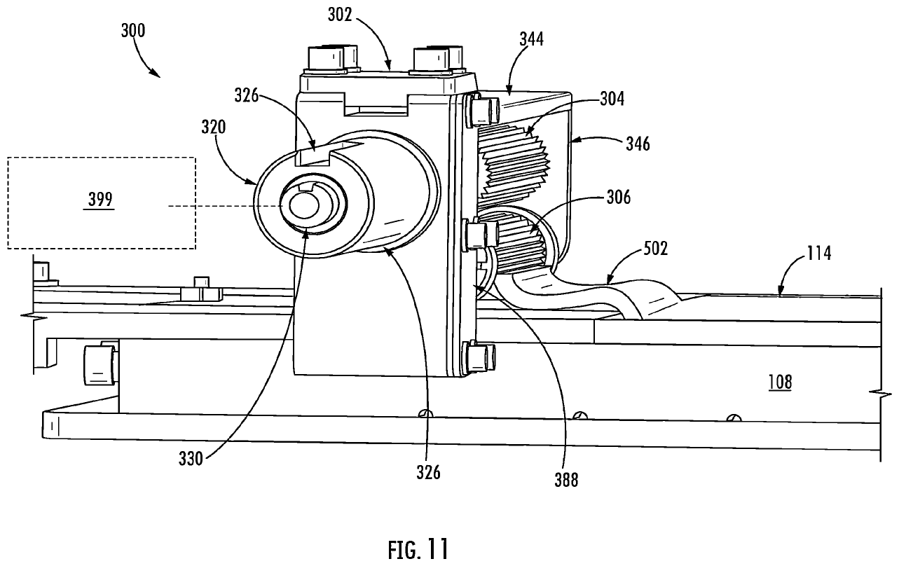

Referring generally to FIGS. 10-14, a tread extraction process 600 is shown and described, according to an example embodiment. The tread extractor assembly 300 operably coupled to the rail assembly 500 may be used to advance and/or complete the tread extraction process 600. Referring specifically to FIG. 10, the tread extractor assembly 300 is shown in confronting relation to the mold 108. The chassis 302 is positioned such that the first spindle 304 and the second spindle 306 are positioned between the first chassis flange 344 and the mold 108. The tire tread 114 within the mold 108 includes an additional portion, shown as a tab or protrusion 502, extending from one end of the tire tread 114 that is configured for selectively coupling with the tread extractor assembly 300. In some embodiments, the tab 502 is formed by a tab cavity formed in the upper mold. The tab cavity is in fluid communication with the mold cavity 108 such that the tab 502 is formed at the same time as the tire tread 114. In some embodiments, such as when the upper mold is absent, a tab cavity may be formed in the lower mold. A tab ejector assembly 504 is configured to release the tab 502 from the mold 108 and position the tab 502 in position for being received within the gap 312 defined between the first spindle 304 and the second spindle 306. The tab ejector assembly 504 may be operably coupled to either of the upper mold or the lower mold.

The rail assembly 500 is configured to translate along the length of the mold 108 to move the tread extractor assembly 300 into engagement with the tab 502. As the rail assembly 500 moves the tread extractor assembly 300 closer to the tab 502, an actuator of the rail assembly 500 coupled to the first spindle 304 causes the first spindle 304 to rotate about the first axis 315 such that the first engagement portion 350 of the first spindle 304 proximate to the gap 312 moves in a tangential direction away from the tab 502. The actuator, by rotation of the first spindle 304, causes rotation of the second spindle 306 about the second axis 317 relative to the chassis 302 such that the second engagement portion 370 proximate to the gap 312 moves in a tangential direction away from the tab 502. The rotation of the first spindle 304 and the second spindle 306 inward and away from the tab 502 facilitate positioning of the tab 502 in the gap 312 and the rail assembly 500 moves the tread extractor assembly 300 into engagement with the tab 502 (FIG. 11).

In some embodiments, the first mold engagement body 376 and the second mold engagement body 378 engage a top surface of the mold 108 (e.g., sidewall 210, track 216). The first mold engagement body 376 and the second mold engagement body 378 may roll across the mold 108 as the rail assembly 500 traverses that length of the mold 108. The first mold engagement body 376 and the second mold engagement body 378 also maintain the second spindle 306 in spaced relation relative to the mold 108.

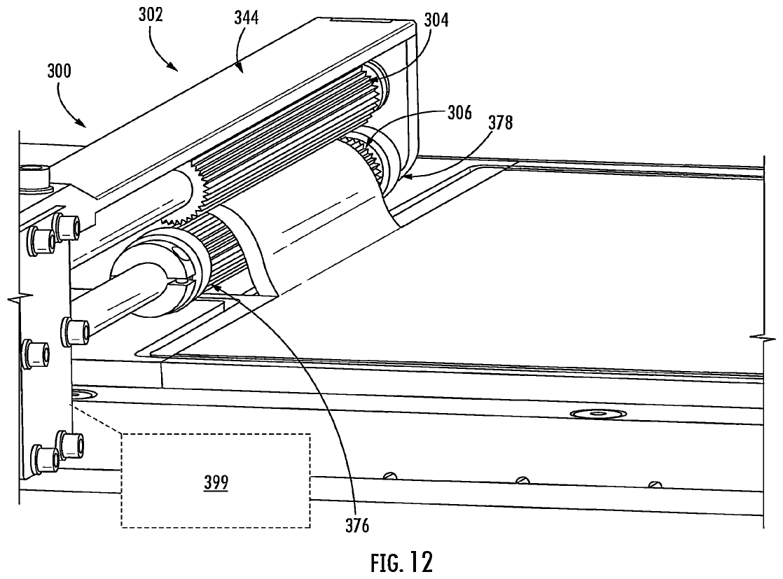

Referring to FIG. 12, the tab 502 is shown clamped between the first spindle 304 and the second spindle 306. After the tab 502 is clamped between the first spindle 304 and the second spindle 306, the first spindle 304 and the second spindle 306 are operated to stop rotating about their respective axes.

After the first spindle 304 and the second spindle 306 are operated to stop rotating about their respective axes, the chassis 302 is rotated by the rail assembly 500 such that the first chassis flange 344 is rotated toward the tire tread 114, as shown in FIG. 13. The cylindrical body 324 is operably coupled to the rail assembly 500 such that the rail assembly 500 rotates the cylindrical body 324 and the rest of the chassis 302 about the first axis 315 such that the first chassis flange 344 is rotated toward the tire tread 114 (e.g., in the clockwise direction relative to FIG. 13). In some embodiments, the chassis 302 is rotated about the first axis 315 by the rail assembly 500 such that the first chassis flange 344 rotates away from the tire tread 114 (e.g., in a counterclockwise direction relative to FIG. 13). After the tab 502 has been clamped within the tread extractor assembly 300 and the tread extractor assembly 300 has been rotated, the rail assembly 500 translates along the length of the tread mold 108 to extract the tire tread 114 from the mold 108.

Referring now to FIG. 14, an exemplary flow diagram of the tread extraction process 600 is shown. At 602, the tread extractor assembly 300, which is operably coupled to the rail assembly 500, is positioned above a tire tread positioned within a tread mold, such as the mold 108.

At 604, the first spindle 304 and the second spindle 306 are rotated by the rail assembly 500. The first spindle 304 and the second spindle 306 may be controlled to rotate for a set amount of time or for a set amount of rotations. Such control may be effectuated by the controller 399 described above, for example.

At 606, a portion of the tire tread positioned within the mold, such as the tab 502, is extracted (e.g., ejected) from the mold by a tab ejecting system, such as the tab ejector assembly 504. In some embodiments, the tab 502 is ejected from the mold automatically in response to a signal received from the controller 399. The portion of the tire tread is positioned by the tab ejecting system such that the portion of the tire tread is able to be engaged by the tread extractor assembly 300.

At 608, the rail assembly 500 translates the tread extractor assembly 300 toward the portion of the tire tread that is ejected from the mold. The tread extractor assembly 300 is translated while the first spindle 304 and the second spindle 306 are rotating. The tread extractor assembly 300 is translated until the portion of the tire tread engages at least one of the first spindle 304 and the second spindle 306. The tab 502 is clamped by the tread extractor assembly 300 automatically and without assistance from an operator. In some embodiments, the clamping may occur automatically and an operator may provide visual or manual inspection of the clamping operation.

At 610, the portion of the tire tread is clamped within the tread extractor assembly 300. Specifically, the portion of the tire tread is clamped within the gap 312 between the first spindle 304 and the second spindle 306.

At 612, the rotation of the first spindle 304 and the second spindle 306 is locked such that the rotation of the first spindle 304 and the second spindle 306 is prevented and the tab 502 is unable to be removed from the gap. Locking the rotation of the first spindle 304 and the second spindle 306 may occur automatically. The portion of the tire tread is pulled between the first spindle 304 and the second spindle 306 until the portion of the tire tread is secured by the tread extractor assembly 300. The first spindle 304 and the second spindle 306 are configured to handle treads having large amounts of flash, as shown in FIG. 13.

At 614, the tread extractor assembly 300 is pivoted relative to the rail assembly 500 and the mold 108. In some embodiments, the tread extractor assembly 300 is pivoted about the first axis 315 by between about 20 to about 60 degrees. In some embodiments, the tread extractor assembly 300 is pivoted about the first axis 315 by between about 40 to about 80 degrees. The tread extractor assembly 300 may be pivoted in either rotational direction about the first axis 315.

At 616, the rail assembly 500 translates the tread extractor assembly 300 along the length of the mold to remove (e.g., extract) the tire tread from the mold. The rail assembly 500 moves along the mold in a direction toward an end of the tire tread opposite to the end of the tire tread having the tab 502 (e.g., the portion of the tire tread configured for clamping within the tread extractor assembly 300). In some embodiments, the tread extractor assembly 300 engages (e.g., is braced against) the tread mold as the rail assembly 500 translates the tread extractor assembly 300 along the length of the tread mold. After the tread 114 has been removed from the mold 108, the first spindle 304 and the second spindle 306 may be unlocked and allowed to rotate such that the tread 114 is removed form the tread extractor assembly 300.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled direction to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the systems chosen and on design requirements. All such variations are within the scope of the disclosure.

1. A tread extractor assembly comprising:
a chassis;
a first spindle rotatably coupled to the chassis and configured to rotate in a first direction; and
a second spindle rotatably coupled to the chassis and configured to rotate in a second direction opposite to the first direction,
the first spindle and the second spindle being disposed to extend substantially in parallel to one another; and
the first spindle and the second spindle being separated by a gap, the gap being configured to receive a portion of a tire tread.

2. The tread extractor assembly of claim 1, further comprising a gearbox coupled to the chassis, wherein:
the first spindle includes a first spindle gear positioned within the gearbox; and
the second spindle includes a second spindle gear positioned within the gearbox, the second spindle gear configured to be in a meshing engagement with the first spindle gear.

3. The tread extractor assembly of claim 2, further comprising an actuator operably coupled to the first spindle and configured to rotate the first spindle in the first direction, wherein rotation of the first spindle in the first direction causes rotation of the second spindle in the second direction via the meshing engagement between the first spindle gear and the second spindle gear.

4. The tread extractor assembly of claim 3, wherein the first spindle gear and the second spindle gear include the same number of gear teeth such that the actuator causes rotation of both the first spindle and the second spindle at the same angular speed.

5. The tread extractor assembly of claim 1, wherein:
the first spindle includes a first engagement portion extending axially along a length of the first spindle; and
the second spindle includes a second engagement portion extending axially along a length of the second spindle such that at least a portion of the second engagement portion is offset radially from the first engagement portion.

6. The tread extractor assembly of claim 1, wherein the chassis is configured to be pivotally coupled to a rail assembly such that the chassis is pivotable relative to the rail assembly.

7. The tread extractor assembly of claim 6, wherein the chassis is configured to pivot relative to the rail assembly about an axis of the first spindle.

8. The tread extractor assembly of claim 1, wherein the chassis further comprises:
a first end and a second end opposite to the first end;
a coupling body configured to be pivotally coupled to a rail assembly;
a first flange extending between the coupling body and the second end; and
a second flange extending from the first flange at the second end of the chassis, the second flange rotatably coupled to the first spindle and the second spindle.

9. The tread extractor assembly of claim 8, wherein the first spindle extends through the coupling body.

10. The tread extractor assembly of claim 9, wherein the first spindle is configured to rotate independently relative to the coupling body.

11. A method of extracting a tire tread from a tread mold using a tread extractor assembly, the method comprising:
positioning the tread extractor assembly above the tire tread positioned within the tread mold;
rotating a first spindle and a second spindle;
extracting a portion of the tire tread from the tread mold using a tab ejector;
translating the tread extractor assembly toward the portion of the tire tread while the first spindle and the second spindle are rotating;
clamping the portion of the tire tread between the first spindle and the second spindle;
stopping rotation of the first spindle and the second spindle;
pivoting the tread extractor assembly to a tilted position relative to the tread mold; and
translating the tread extractor assembly along a length of the tread mold to extract the tire tread from the tread mold.

12. The method of claim 11, further comprising controlling, by a controller, the rotation of the first spindle and the second spindle to rotate for a set amount of time.

13. The method of claim 11, further comprising controlling, by a controller, the rotation of the first spindle and the second spindle to rotate for a set number of rotations.

14. The method of claim 11, further comprising ejecting a tab from the tread mold automatically in response to a signal received from a controller.

15. The method of claim 11, further comprising translating the tread extractor assembly until the portion of the tire tread engages at least one of the first spindle and the second spindle.

16. The method of claim 11, wherein clamping the portion of the tire tread occurs automatically.

17. The method of claim 11, further comprising clamping the portion of the tire tread within a gap between the first spindle and the second spindle.

18. The method of claim 11, further comprising pivoting the tread extractor assembly about a first axis by between about 20 to about 60 degrees.

19. The method of claim 11, further comprising pivoting the tread extractor assembly about a first axis by between about 40 to about 80 degrees.

20. The method of claim 11, further comprising pivoting the tread extractor assembly in a first rotational direction or a second rotational direction about a first axis.
